(19) United States
(12) Patent Application Publication
(10) Pub. No.: US 2023/0171749 A1
(43) Pub. Date: Jun. 1, 2023

(54) TIME DOMAIN INTERLEAVING FOR PHYSICAL SHARED CHANNEL COMMUNICATIONS

(71) Applicant: QUALCOMM Incorporated, San Diego, CA (US)

(72) Inventors: Qiaoyu LI, Beijing (CN); Yu ZHANG, San Diego, CA (US); Hao XU, Beijing (CN); Liangming WU, Beijing (CN); Chao WEI, Beijing (CN); Chenxi HAO, Beijing (CN)

(21) Appl. No.: 17/997,063

(22) PCT Filed: Jun. 12, 2020
(86) PCT No.: PCT/CN2020/095721

§ 371 Date: Oct. 25, 2022

(51) Int. Cl. H04W 72/0446; H04L 1/00; H04L 5/00; H04W 72/23

(52) U.S. Cl. CPC H04W 72/0446; H04L 1/0071; H04L 5/0046; H04W 72/23

(57) ABSTRACT

Various aspects of the present disclosure generally relate to wireless communication. In some aspects, a wireless communication device may determine a time domain interleaving configuration to be used for a transport block of a communication, wherein the time domain interleaving configuration maintains a frequency domain resource distribution of a frequency domain resource mapping scheme used for the transport block, and transmit the communication on one or more physical shared channels using the time domain interleaving configuration for the transport block of the communication. Numerous other aspects are provided.

### FIELD OF THE DISCLOSURE

Aspects of the present disclosure generally relate to wireless communication and to techniques and apparatuses for time domain interleaving for physical shared channel communications.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, and/or the like.

The above multiple access technologies have been adopted in various telecommunication standards to provide a common protocol that enables different user equipment to communicate on a municipal, national, regional, and even global level. New Radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. As the demand for mobile broadband access continues to increase, further improvements in LTE, NR, and other radio access technologies remain useful.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with various aspects of the present disclosure.

FIG. 2 is a diagram illustrating an example of a base station in communication with a UE in a wireless network, in accordance with various aspects of the present disclosure.

FIG. 3 is a diagram illustrating an example resource structure for wireless communication, in accordance with various aspects of the present disclosure.

FIG. 4 is a diagram illustrating an example of a frequency domain resource mapping scheme, in accordance with various aspects of the present disclosure.

FIGS. 5-7 are diagrams illustrating examples associated with time domain interleaving for physical shared channel communications, in accordance with various aspects of the present disclosure.

FIGS. 8-9 are diagrams illustrating example processes associated with time domain interleaving for physical shared channel communications, in accordance with various aspects of the present disclosure.

### SUMMARY

In some aspects, a method of wireless communication, performed by a wireless communication device, may include determining a time domain interleaving configuration to be used for a transport block of a communication, wherein the time domain interleaving configuration maintains a frequency domain resource distribution of a frequency domain resource mapping scheme used for the transport block; and transmitting the communication on one or more physical shared channels using the time domain interleaving configuration for the transport block of the communication.

In some aspects, a method of wireless communication, performed by a wireless communication device, may include determining a time domain interleaving configuration to be used for a transport block of a communication, wherein the time domain interleaving configuration maintains a frequency domain resource distribution of a frequency domain resource mapping scheme used for the transport block; and receiving the communication on one or more physical shared channels using the time domain interleaving configuration for the transport block of the communication.

In some aspects, a wireless communication device may include a memory and one or more processors operatively coupled to the memory. The memory and the one or more processors may be configured to determine a time domain interleaving configuration to be used for a transport block of a communication, wherein the time domain interleaving configuration maintains a frequency domain resource distribution of a frequency domain resource mapping scheme used for the transport block; and transmit the communication on one or more physical shared channels using the time domain interleaving configuration for the transport block of the communication.

In some aspects, a wireless communication device may include a memory and one or more processors operatively coupled to the memory. The memory and the one or more processors may be configured to determine a time domain interleaving configuration to be used for a transport block of a communication, wherein the time domain interleaving configuration maintains a frequency domain resource distribution of a frequency domain resource mapping scheme used for the transport block; and receive the communication on one or more physical shared channels using the time domain interleaving configuration for the transport block of the communication.

In some aspects, a non-transitory computer-readable medium may store one or more instructions for wireless communication. The one or more instructions, when executed by one or more processors of a wireless communication device, may cause the one or more processors to determine a time domain interleaving configuration to be used for a transport block of a communication, wherein the time domain interleaving configuration maintains a frequency domain resource distribution of a frequency domain resource mapping scheme used for the transport block; and transmit the communication on one or more physical shared channels using the time domain interleaving configuration for the transport block of the communication.

In some aspects, a non-transitory computer-readable medium may store one or more instructions for wireless communication. The one or more instructions, when executed by one or more processors of a wireless communication device, may cause the one or more processors to determine a time domain interleaving configuration to be used for a transport block of a communication, wherein the time domain interleaving configuration maintains a frequency domain resource distribution of a frequency domain resource mapping scheme used for the transport block; and receive the communication on one or more physical shared channels using the time domain interleaving configuration for the transport block of the communication.

In some aspects, an apparatus for wireless communication may include means for determining a time domain interleaving configuration to be used for a transport block of a communication, wherein the time domain interleaving configuration maintains a frequency domain resource distribution of a frequency domain resource mapping scheme used for the transport block; and means for transmitting the communication on one or more physical shared channels using the time domain interleaving configuration for the transport block of the communication.

In some aspects, an apparatus for wireless communication may include means for determining a time domain interleaving configuration to be used for a transport block of a communication, wherein the time domain interleaving configuration maintains a frequency domain resource distribution of a frequency domain resource mapping scheme used for the transport block; and means for receiving the communication on one or more physical shared channels using the time domain interleaving configuration for the transport block of the communication.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with a 5G or NR radio access technologies (RAT), aspects of the present disclosure can be applied to other RATs, such as a 3G RAT, a 4G RAT, and/or a RAT subsequent to 5G (e.g., 6G).

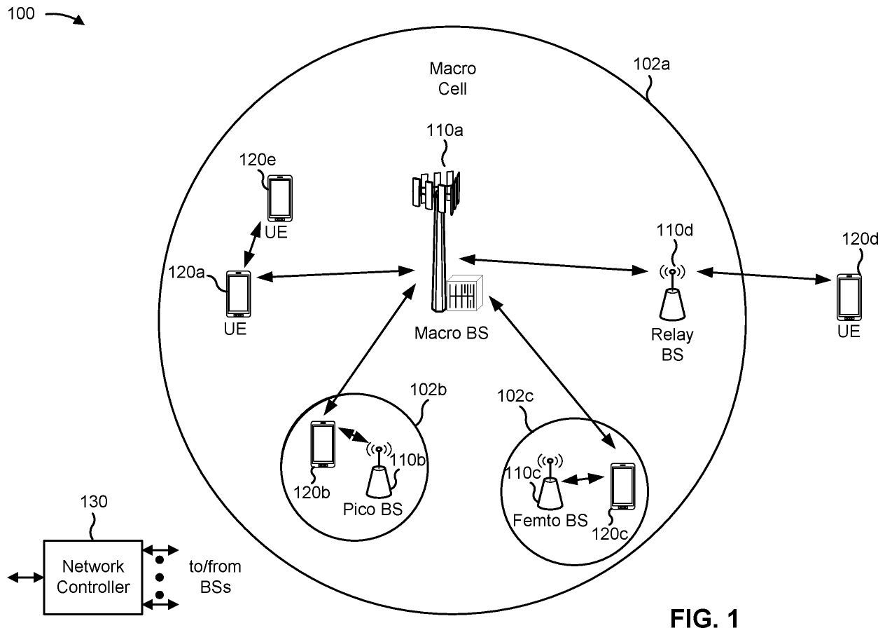

FIG. 1 is a diagram illustrating an example of a wireless network 100, in accordance with various aspects of the present disclosure. The wireless network 100 may be or may include elements of a 5G (NR) network, an LTE network, and/or the like. The wireless network 100 may include a number of base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, a transmit receive point (TRP), and/or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. ABS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. ABS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay station 110d may communicate with macro BS 110a and a UE 120d in order to facilitate communication between BS 110a and UE 120d. A relay station may also be referred to as a relay BS, a relay base station, a relay, and/or the like.

Wireless network 100 may be a heterogeneous network that includes BSs of different types, e.g., macro BSs, pico BSs, femto BSs, relay BSs, and/or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components, memory components, and/or the like. In some aspects, the processor components and the memory components may be coupled together. For example, the processor components (e.g., one or more processors) and the memory components (e.g., a memory) may be operatively coupled, communicatively coupled, electronically coupled, electrically coupled, and/or the like.

In general, any number of wireless networks may be deployed in a given geographic area. Each wireless network may support a particular RAT and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere herein as being performed by the base station 110.

As indicated above, FIG. 1 is provided as an example. Other examples may differ from what is described with regard to FIG. 1.

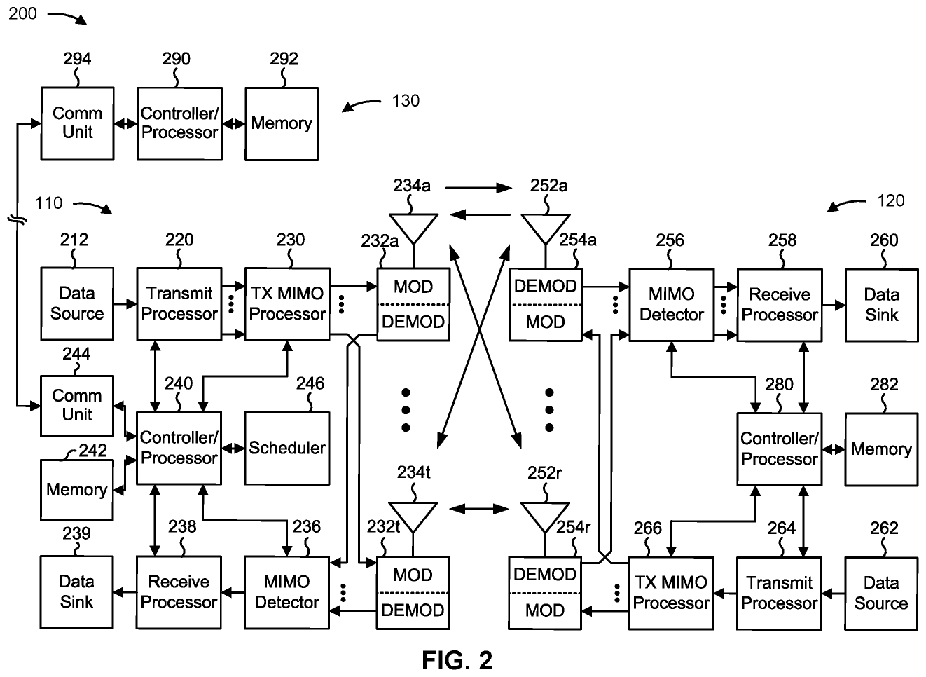

FIG. 2 is a diagram illustrating an example 200 of a base station 110 in communication with a UE 120 in a wireless network 100, in accordance with various aspects of the present disclosure. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., a cell-specific reference signal (CRS), a demodulation reference signal (DMRS), and/or the like) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like. In some aspects, one or more components of UE 120 may be included in a housing 284.

Network controller 130 may include communication unit 294, controller/processor 290, and memory 292. Network controller 130 may include, for example, one or more devices in a core network. Network controller 130 may communicate with base station 110 via communication unit 294.

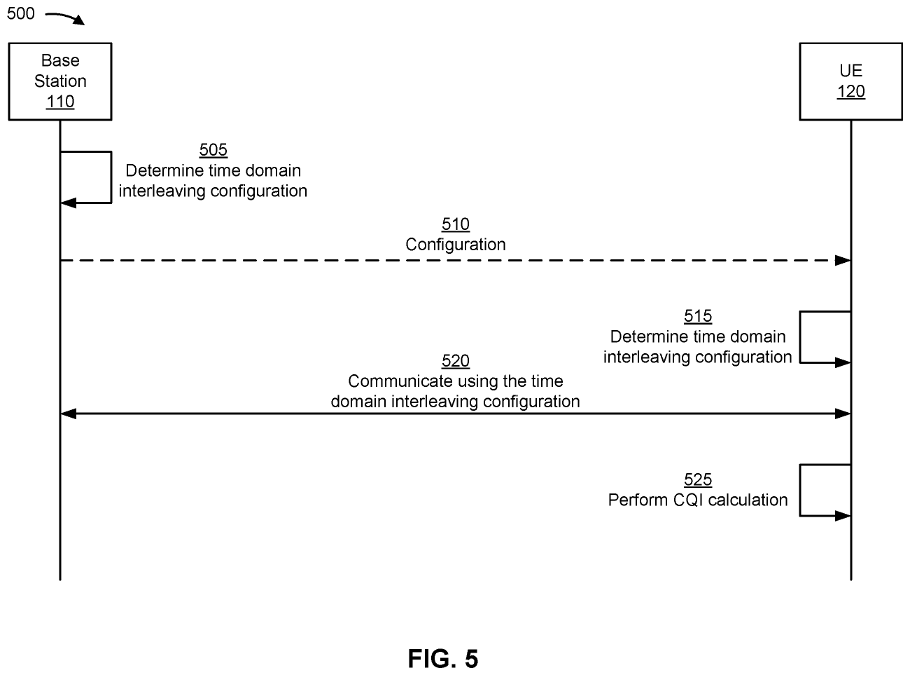

On the uplink, at UE 120, a transmit processor 264 may receive and process data from a data source 262 and control information (e.g., for reports that include RSRP, RSSI, RSRQ, CQI, and/or the like) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM, CP-OFDM, and/or the like), and transmitted to base station 110. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein, for example, as described with reference to FIGS. 5-9.

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein, for example, as described with reference to FIGS. 5-9.

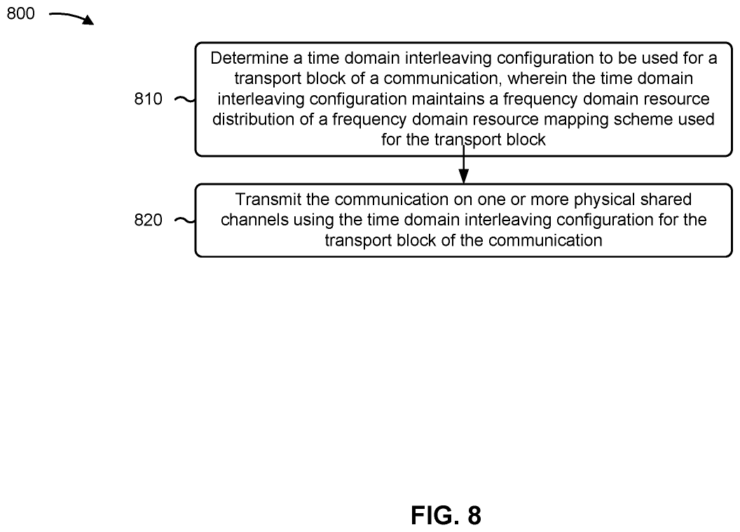

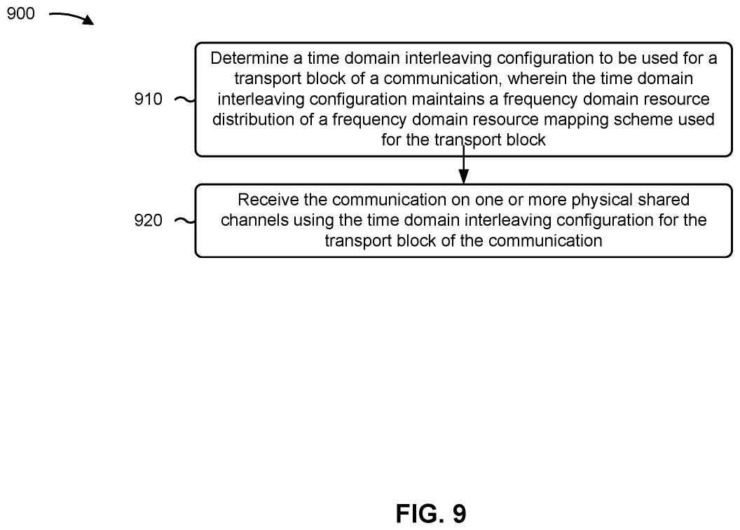

Controller/processor 240 of base station 110, controller/processor 280 of UE 120, and/or any other component(s) of FIG. 2 may perform one or more techniques associated with time domain interleaving for physical shared channel communications, as described in more detail elsewhere herein. For example, controller/processor 240 of base station 110, controller/processor 280 of UE 120, and/or any other component(s) of FIG. 2 may perform or direct operations of, for example, process 800 of FIG. 8, process 900 of FIG. 9, and/or other processes as described herein. Memories 242 and 282 may store data and program codes for base station 110 and UE 120, respectively. In some aspects, memory 242 and/or memory 282 may include a non-transitory computer-readable medium storing one or more instructions (e.g., code, program code, and/or the like) for wireless communication. For example, the one or more instructions, when executed (e.g., directly, or after compiling, converting, interpreting, and/or the like) by one or more processors of the base station 110 and/or the UE 120, may cause the one or more processors, the UE 120, and/or the base station 110 to perform or direct operations of, for example, process 800 of FIG. 8, process 900 of FIG. 9, and/or other processes as described herein. In some aspects, executing instructions may include running the instructions, converting the instructions, compiling the instructions, interpreting the instructions, and/or the like.

As described herein, “wireless communication device” may refer to a UE 120 or a base station 110. In some aspects, a wireless communication device may include means for determining a time domain interleaving configuration to be used for a transport block of a communication, wherein the time domain interleaving configuration maintains a frequency domain resource distribution of a frequency domain resource mapping scheme used for the transport block, means for transmitting the communication on one or more physical shared channels using the time domain interleaving configuration for the transport block of the communication, means for receiving the communication on one or more physical shared channels using the time domain interleaving configuration for the transport block of the communication, and/or the like. In some aspects, such means may include one or more components of UE 120 described in connection with FIG. 2, such as controller/processor 280, transmit processor 264, TX MIMO processor 266, MOD 254, antenna 252, DEMOD 254, MIMO detector 256, receive processor 258, and/or the like. In some aspects, such means may include one or more components of base station 110 described in connection with FIG. 2, such as antenna 234, DEMOD 232, MIMO detector 236, receive processor 238, controller/processor 240, transmit processor 220, TX MIMO processor 230, MOD 232, antenna 234, and/or the like.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of processor 280.

As indicated above, FIG. 2 is provided as an example. Other examples may differ from what is described with regard to FIG. 2.

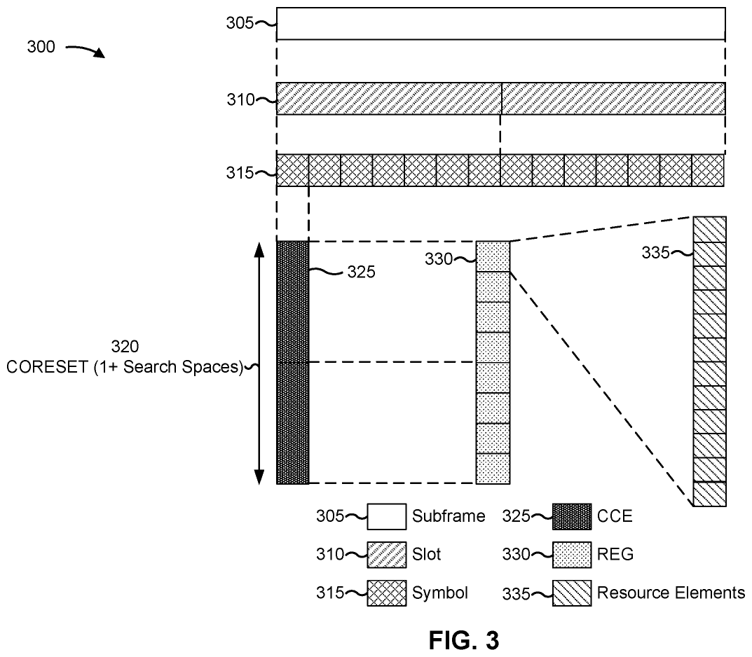

FIG. 3 is a diagram illustrating an example resource structure 300 for wireless communication, in accordance with various aspects of the present disclosure. Resource structure 300 shows an example of various groups of resources described herein. As shown, resource structure 300 may include a subframe 305. Subframe 305 may include multiple slots 310. While resource structure 300 is shown as including 2 slots per subframe, a different number of slots may be included in a subframe (e.g., 4 slots, 8 slots, 16 slots, 32 slots, and/or the like). In some aspects, different types of transmission time intervals (TTIs) may be used, other than subframes and/or slots. A slot 310 may include multiple symbols 315, such as 7 symbols or 14 symbols per slot.

The potential control region of a slot 310 may be referred to as a control resource set (CORESET) 320 and may be structured to support an efficient use of resources, such as by flexible configuration or reconfiguration of resources of the CORESET 320 for one or more PDCCHs, one or more physical downlink shared channels (PDSCHs), and/or the like. In some aspects, the CORESET 320 may occupy the first symbol 315 of a slot 310, the first two symbols 315 of a slot 310, or the first three symbols 315 of a slot 310. Thus, a CORESET 320 may include multiple resource blocks (RBs) in the frequency domain, and either one, two, or three symbols 315 in the time domain. In some aspects, an RB may be referred to as a physical RB (PRB). In 5G, a quantity of resources included in the CORESET 320 may be flexibly configured, such as by using radio resource control (RRC) signaling to indicate a frequency domain region (e.g., a quantity of resource blocks) and/or a time domain region (e.g., a quantity of symbols) for the CORESET 320.

As illustrated, a symbol 315 that includes CORESET 320 may include one or more control channel elements (CCEs) 325, shown as two CCEs 325 as an example, that span a portion of the system bandwidth. A CCE 325 may include downlink control information (DCI) that is used to provide control information for wireless communication. A base station may transmit DCI during multiple CCEs 325 (as shown), where the quantity of CCEs 325 used for transmission of DCI represents the aggregation level (AL) used by the BS for the transmission of DCI. In FIG. 3, an aggregation level of two is shown as an example, corresponding to two CCEs 325 in a slot 310. In some aspects, different aggregation levels may be used, such as 1, 4, 8, 16, and/or the like.

Each CCE 325 may include a fixed quantity of resource element groups (REGs) 330, shown as 4 REGs 330, or may include a variable quantity of REGs 330. In some aspects, the quantity of REGs 330 included in a CCE 325 may be specified by a REG bundle size. A REG 330 may include one resource block, which may include 12 resource elements (REs) 335 within a symbol 315. A resource element 335 may occupy one subcarrier in the frequency domain and one OFDM symbol in the time domain.

A search space may include all possible locations (e.g., in time and/or frequency) where a PDCCH may be located. A CORESET 320 may include one or more search spaces, such as a UE-specific search space, a group-common search space, and/or a common search space. A search space may indicate a set of CCE locations where a UE may find PDCCHs that can potentially be used to transmit control information to the UE. The possible locations for a PDCCH may depend on whether the PDCCH is a UE-specific PDCCH (e.g., for a single UE) or a group-common PDCCH (e.g., for multiple UEs), an aggregation level being used, and/or the like. A possible location (e.g., in time and/or frequency) for a PDCCH may be referred to as a PDCCH candidate, and the set of all possible PDCCH locations may be referred to as a search space. For example, the set of all possible PDCCH locations for a particular UE may be referred to as a UE-specific search space. Similarly, the set of all possible PDCCH locations across all UEs may be referred to as a common search space. The set of all possible PDCCH locations for a particular group of UEs may be referred to as a group-common search space.

A CORESET 320 may be interleaved or non-interleaved. An interleaved CORESET 320 may have CCE-to-REG mapping such that adjacent CCEs are mapped to scattered REG bundles in the frequency domain (e.g., adjacent CCEs are not mapped to consecutive REG bundles of the CORESET 320). A non-interleaved CORESET 320 may have a CCE-to-REG mapping such that all CCEs are mapped to consecutive REG bundles (e.g., in the frequency domain) of the CORESET 320.

As indicated above, FIG. 3 is provided as an example. Other examples may differ from what is described with respect to FIG. 3.

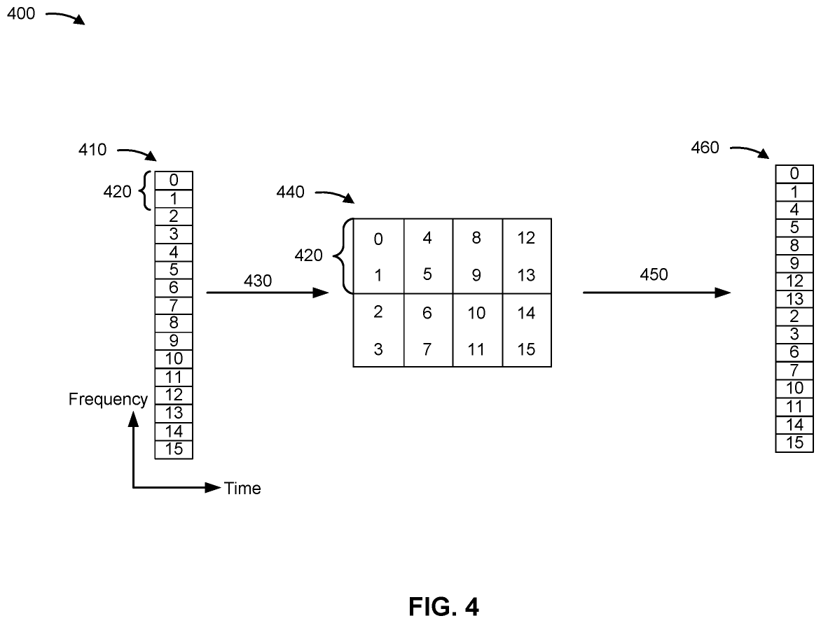

FIG. 4 is a diagram illustrating an example 400 of a frequency domain resource mapping scheme, in accordance with various aspects of the present disclosure. The frequency domain resource mapping scheme may be a virtual resource block (VRB) to physical resource block (PRB) mapping scheme. In particular, example 400 may illustrate an example of an interleaved VRB to PRB mapping. A VRB may include data from one or more concatenated code blocks (CBs). For example, REs of the concatenated CBs may be modulated and mapped to one or more VRBs (e.g., in a virtual resource grid and/or the like). As shown in FIG. 4 and by reference number 410, a set of VRBs may include one or more VRB bundles 420. A VRB bundle 420 may be configured to include two VRBs (e.g., the VRB bundle 420 may be configured to have a size of two VRBs).

As shown by reference number 430, the VRB bundles 420 may be written into a matrix 440 according to an interleaving configuration. For example, the interleaving configuration may indicate a quantity of rows that are to be used for interleaving. As shown, the quantity of rows may be three (e.g., the matrix 440 may include three rows). The VRB bundles 420 may be written into the matrix 440 by row, such that the VRB bundles 420 are written to a first row of the matrix 440 first, a second row of the matrix 440 second, and so forth.

As shown by reference number 450, the VRB bundles 410 may be read out of the matrix 440, in VRB bundle units, and mapped to one or more PRBs 460. For example, the VRB bundles 420 may be read out of the matrix 440, by column, and mapped to the one or more PRBs 460. As a result, the mapping of VRB bundles 420 to the one or more PRBs 460 may result in an interleaving of the VRB bundles 420. Therefore, coded bits of a CB may be allocated to different resources in the frequency domain in the PRBs. This results in increased frequency domain diversity for coded bits of a CB within the PRBs.

In some cases, coded bits of a CB may not include time domain diversity. That is, the coded bits of the CB may be sequentially mapped in the time domain (e.g., due to a decoding requirement and/or the like, such that a CB may be decoded by a wireless communication device (e.g., a UE or a base station) alone, without waiting to receive any additional CBs). However, in some cases, performance of a communication may be negatively impacted by not including time domain diversity within a transport block (or CBs included in the transport block) of a communication. For example, in a high Doppler scenario or a high speed scenario, parameters of a channel may vary frequently in the time domain. As a result, a communication that includes a CB that does not include time domain diversity among coded bits of the CB may experience poor performance in a high Doppler scenario.

Some techniques and apparatuses described herein enable a wireless communication device (e.g. a UE or a base station) to introduce time domain diversity among coded bits of a CB using time domain interleaving for physical shared channel communications. A time domain interleaving configuration may maintain the frequency domain diversity achieved through the VRB-to-PRB mapping described above. For example, the time domain interleaving configuration may be applied to one or more VRBs after CB concatenation. As a result, time domain diversity may be introduced among coded bits of the CB while also maintaining the frequency domain diversity achieved through VRB-to-PRB mapping. This results in improved performance of communications by ensuring both time domain diversity and frequency domain diversity for the communication.

As indicated above, FIG. 4 is provided as an example. Other examples may differ from what is described with respect to FIG. 4.

FIG. 5 is a diagram illustrating an example 500 associated with time domain interleaving for physical shared channel communications, in accordance with various aspects of the present disclosure. As shown in FIG. 5, a base station 110 and a UE 120 may communicate with one another in a wireless network (e.g., wireless network 100).

As show by reference number 505, the base station 110 may determine a time domain interleaving configuration to be used for communications between the base station 110 and the UE 120. The time domain interleaving configuration may be a time domain interleaving configuration to be used for a transport block of a communication. In some aspects, the time domain interleaving configuration may be compatible with a frequency domain resource mapping scheme used for the transport block. For example, the time domain interleaving configuration may be compatible with a VRB-to-PRB mapping scheme used for the transport block, such as the VRB-to-PRB mapping scheme described above with respect to FIG. 4. The time domain interleaving configuration may be compatible with the frequency domain resource mapping scheme in that the time domain interleaving configuration may maintain or not destroy the frequency domain diversity achieved using the frequency domain resource mapping scheme. The time domain interleaving configuration may maintain a frequency domain resource distribution of a frequency domain resource mapping scheme used for the transport block with respect to a CB of the transport block (e.g., may maintain a frequency domain resource distribution of coded bits of a CB achieved using the frequency domain resource mapping scheme). For example, the time domain interleaving configuration may be applied to one or more VRBs, prior to performance of the VRB-to-PRB mapping scheme used for the transport block.

In some aspects, a wireless communication device (e.g., a UE 120 or a base station 110) may encode data of a communication in a transport block that includes one or more code blocks (CBs). A CB may include a plurality of coded bits. The wireless communication device may concatenate the one or more CBs and may modulate resource elements (REs) of the concatenated CBs. The wireless communication device may apply mapping schemes to the concatenated CBs. For example, the wireless communication device may apply a layer mapping scheme, a frequency domain mapping scheme, and/or a time domain mapping scheme to the concatenated CBs to map the concatenated CBs to one or more PRBs to be used to transmit the communication. In some aspects, the layer mapping scheme may be applied to the concatenated CBs before the frequency domain mapping scheme or the time domain mapping scheme. The frequency domain mapping scheme and/or the time domain mapping scheme may include mapping the modulated REs of the concatenated CBs to REs of one or more VRBs (e.g., in a virtual resource grid).

In some aspects, the time domain interleaving configuration may be a time domain interleaving configuration applied to the one or more VRBs after the CBs are concatenated. In some aspects, the time domain interleaving configuration may be applied after the frequency domain mapping scheme or before the frequency domain mapping scheme. In some aspects, the time domain interleaving configuration may be applied before a frequency domain resource mapping, such as the VRB-to-PRB mapping scheme described above with respect to FIG. 4.

In some aspects, the time domain interleaving configuration may be a coded bit interleaving scheme that is applied across an entire transport block (or multiple transport blocks if a communication includes more than one transport block). For example, the coded bits of the transport block may be interleaved (e.g., randomized) to achieve time domain diversity among coded bits of a CB. The coded bit interleaving scheme may be a matrix interleaving scheme or a rectangular interleaving scheme. For example, a matrix may include a quantity of rows and a quantity of columns. The coded bits of the transport block may be read into the matrix by columns (e.g., as individual coded bits or in coded bit bundles (e.g., that include a quantity of coded bits)). The coded bits of the transport block may be read out of the matrix, by rows, and mapped to one or more VRBs or PRBs. The coded bit interleaving scheme may be designed to ensure that frequency domain diversity among coded bits of a CB of the transport block achieved using a resource mapping scheme is maintained.

In some aspects, the time domain interleaving configuration may be a sub-block interleaving scheme. For example, each CB included in a transport block may be segmented into multiple sub-blocks. The sub-blocks of the transport block may be interleaved (e.g., randomized) to achieve time domain diversity among coded bits of a CB. For example, the sub-block interleaving scheme may be a matrix interleaving scheme or a rectangular interleaving scheme, as described above. Sub-blocks of the transport block may be read into the matrix by columns. The sub-blocks of the transport block may be read out of the matrix, by rows, and mapped to one or more VRBs or PRBs. The sub-block interleaving scheme may be designed to ensure that frequency domain diversity among coded bits of a CB of the transport block achieved using a resource mapping scheme is maintained.

In some aspects, the time domain interleaving configuration may be an RE-level mapping scheme. The RE-level mapping scheme may be a scheme for mapping the modulated REs of the CBs to REs of one or more VRBs. In some aspects, the RE-level mapping scheme may be a frequency domain and a time domain RE-level mapping scheme. For example, the modulated REs of the CBs may be mapped to one or more VRBs in both the frequency domain and the time domain. In some aspects, the RE-level mapping scheme may follow a zig-zag pattern. That is, the modulated REs may be mapped to a virtual resource grid (e.g., that includes a plurality of REs over a plurality of OFDM symbols) in a zig-zag pattern such that a first modulated RE is mapped to a first RE in the virtual resource grid and a next modulated RE is mapped to a next RE in the virtual resource grid that is shifted from the first RE by at least one symbol in the time domain and by at least one RE in the frequency domain.

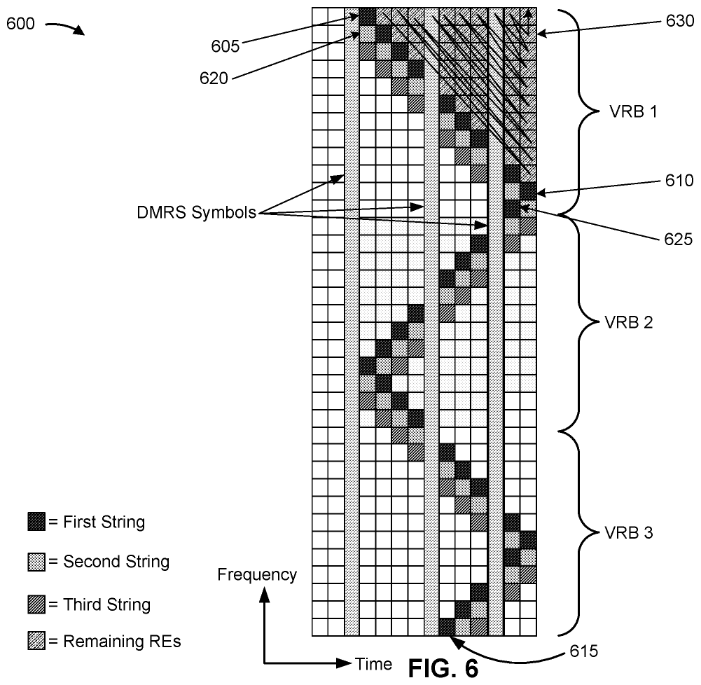

The modulated REs may be mapped to the virtual resource grid following the zig-zag pattern until there are no available REs in the virtual resource grid that can be mapped according to the zig-zag pattern. In some aspects, any remaining REs in the virtual resource grid may be mapped to modulated REs according to a different pattern than the zig-zag pattern. In some aspects, the virtual resource grid may include one or more VRBs. In some aspects, the virtual resource grid may include one or more symbols assigned or allocated for a demodulation reference signal (DMRS). The RE-level mapping scheme may refrain from mapping a modulated RE of a CB to an RE in a symbol that is allocated for a DMRS. The RE-level mapping scheme is described in more detail below with respect to FIG. 6.

In some aspects, the time domain interleaving configuration may be a time domain cyclic shift configuration. The time domain cyclic shift configuration may be a VRB specific cyclic shift. The cyclic shift for a VRB may be defined in terms of a quantity of symbols. That is, a VRB may be associated with a cyclic shift step that is a quantity of symbols. For example, a first VRB may be cyclic shifted by 1 symbol, a second VRB may be cyclic shifted by 2 symbols, a third VRB may be cyclic shifted by 3 symbols, and so on. In that way, time domain diversity across the VRBs may be achieved while also ensuring that the frequency domain diversity achieved using a VRB-to-PRB mapping scheme is maintained.

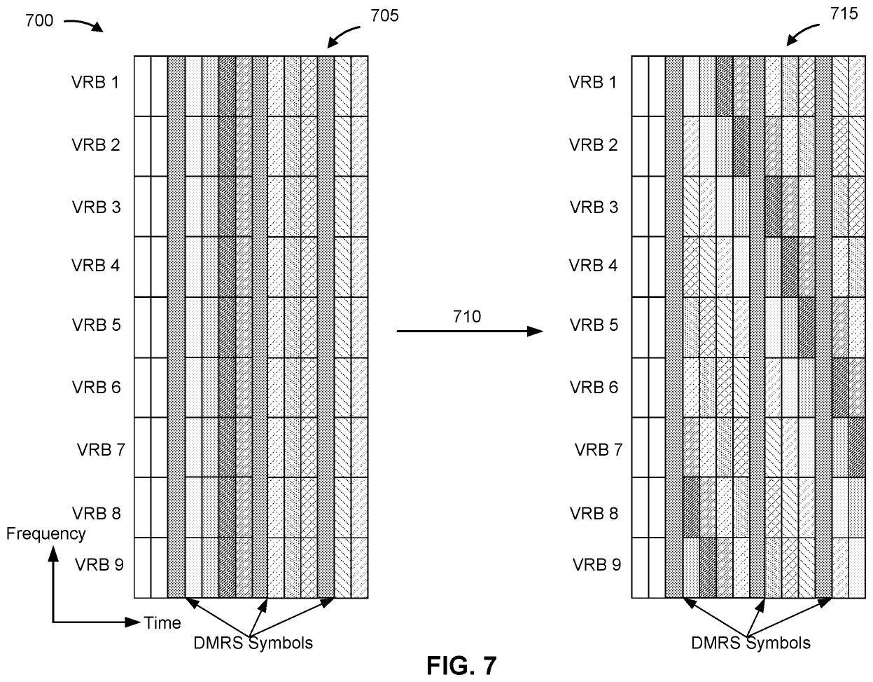

In some aspects, the time domain cyclic shift configuration may not include symbols allocated for a DMRS, symbols for which rate matching is to be used, and/or the like. For example, symbols that are allocated for a DMRS may not be cyclic shifted. In some aspects, symbols that overlap with another signal to be transmitted by a wireless communication device may not be cyclic shifted. In some aspects, rate matching may not be assumed by a wireless communication device when the time domain cyclic shift configuration is used. The time domain cyclic shift configuration is described in more detail below with respect to FIG. 7.

The base station 110 may determine the time domain interleaving configuration based at least in part on a quantity of CBs associated with the transport block, a quantity of CB groups associated with the transport block, a bandwidth associated with the transport block, a quantity of symbols associated with the transport block, a quantity of layers associated with the communication, a quantity of transport blocks associated with the communication, a quantity of symbols of the communication that are associated with a DMRS, a frequency domain interleaving pattern associated with the communication, a modulation and coding scheme associated with the communication, and/or the like.

In some aspects, if a plurality of transport blocks are to be transmitted in a physical shared channel for the communication, the base station 110 may determine a time domain interleaving configuration for a transport block of the plurality of transport blocks, a time domain interleaving configuration for all of the transport blocks, and/or the like. In some aspects, if the communication is to be transmitted using a plurality of slots, such as according to a multi-transmission-time-interval configuration, the base station 110 may determine a time domain interleaving configuration for a slot of the plurality of slots, a time domain interleaving configuration for all of the slots, and/or the like.

As shown by reference number 510, the base station 110 may transmit an indication of the time domain interleaving configuration. In some aspects, the base station 110 may transmit the configuration using radio resource control signaling. In some aspects, the indication of the time domain interleaving configuration for a communication may be indicated in a scheduling downlink control information transmission that schedules the communication. The indication of the time domain interleaving configuration may indicate a type of time domain interleaving (e.g., coded bit interleaving, sub-block interleaving, RE-level mapping, time domain cyclic shift, and/or the like). The indication of the time domain interleaving configuration may indicate parameters associated with the time domain interleaving configuration such as a quantity of rows and/or a quantity of columns of an interleaver (e.g., if a rectangular interleaver or matrix interleaver is to be used), whether rate matching is to be assumed for a communication using the time domain interleaving configuration, one or more communications that are to use the time domain interleaving configuration, and/or the like.

As shown by reference number 515, the UE 120 may receive the indication of the time domain interleaving configuration from the base station 110 and may determine the time domain interleaving configuration. In some aspects, the UE 120 may determine the time domain interleaving configuration based at least in part on the indication of the time domain interleaving configuration from the base station 110. In some aspects, the UE 120 may determine the time domain interleaving configuration in a similar (or the same) manner as the base station 110, as described above.

As shown by reference number 520, the base station 110 and the UE 120 may communicate using the time domain interleaving configuration. For example, the base station 110 may apply the time domain interleaving configuration to one or more transport blocks for a downlink communication. The base station 110 may transmit the downlink communication, on one or more physical downlink shared channels (PDSCH), to the UE 120. The UE 120 may receive the downlink communication using the time domain interleaving configuration (e.g., the UE 120 may monitor for and/or decode one or more PDSCH candidates transmitted by the base station 110 according to the time domain interleaving configuration).

In some aspects, the UE 120 may apply the time domain interleaving configuration to one or more transport blocks for an uplink communication. The UE 120 may transmit the uplink communication, on one or more physical uplink shared channels (PUSCH), to the UE 120. The base station 110 may receive the uplink communication using the time domain interleaving configuration (e.g., the base station 110 may monitor for and/or decode one or more PUSCH candidates transmitted by the UE 120 according to the time domain interleaving configuration).

In some aspects, the UE 120 and/or the base station 110 may apply the time domain interleaving configuration to VRBs associated with a transport block of the communication. The UE 120 and/or the base station 110 may apply a frequency domain resource mapping scheme, such as a VRB-to-PRB mapping scheme, to the VRBs after applying the time domain interleaving configuration to one or more VRBs. The UE 120 and/or the base station 110 may transmit the communication using PRBs (e.g., associated with the VRB-to-PRB mapping scheme). As a result, the communication may include both time domain diversity and frequency domain diversity among coded bits of a CB of the communication.

As shown by reference number 525, the UE 120 may perform a channel quality indicator (CQI) calculation associated with a communication that uses the time domain interleaving configuration. The CQI calculation may be based at least in part on a signal-to-noise ratio (SNR) of the communication, a signal-to-interference-plus-noise ratio (SINR) of the communication, and/or the like. In some aspects, the UE 120 may generate the CQI calculation based at least in part on a channel state information reference signal (CSI-RS) that is transmitted by the base station 110. The UE 120 may transmit a CSI report, to the base station 110, which may include the CQI calculation, a precoding matrix indicator (PMI), a rank indicator (RI), and/or the like. In some aspects, the CSI report may indicate whether time domain interleaving was assumed by the UE 120 when generating the CQI calculation. In some aspects, the CSI report may indicate a type of time domain interleaving that was assumed and/or considered by the UE 120 when generating the CQI calculation. In some aspects, the base station 110 may transmit, to the UE 120, a configuration for the CSI report. The configuration for the CSI report may indicate a type of time domain interleaving that is to be assumed by the UE 120 when generating the CQI calculation. The UE 120 may generate the CQI calculation based at least in part on the type of time domain interleaving indicated in the configuration for the CSI report.

In some aspects, the UE 120 and/or the base station 110 may determine a block error rate (BLER) target for the CQI calculation based at least in part on the type of time domain interleaving configuration used for a communication. In some aspects, a BLER target for the CQI calculation may be based at least in part on whether a time domain interleaving configuration is used for a communication. In some aspects, the UE 120 and/or the base station 110 may determine a bandwidth of a CSI-RS resource associated with the CQI calculation based at least in part on whether a time domain interleaving configuration is used for a communication. In some aspects, if a time domain interleaving configuration is used for a communication, a bandwidth of a CSI-RS resource associated with the CQI calculation may be a sub-band associated with the CSI report for the CQI calculation. In some aspects, if a time domain interleaving configuration is used for a communication, a bandwidth of a CSI-RS resource associated with the CQI calculation may be a bandwidth part (BWP) associated with the communication.

As a result, a time domain interleaving configuration for a transport block of a communication may maintain the frequency domain diversity achieved through the VRB-to-PRB mapping described above. For example, the time domain interleaving configuration may be applied to one or more VRBs after CB concatenation. Therefore, time domain diversity may be introduced among coded bits of a CB while also maintaining the frequency domain diversity achieved through VRB-to-PRB mapping. This results in improved performance of communications by ensuring both time domain diversity and frequency domain diversity for the communication.

As indicated above, FIG. 5 is provided as an example. Other examples may differ from what is described with respect to FIG. 5.

FIG. 6 is a diagram illustrating an example 600 associated with time domain interleaving for physical shared channel communications, in accordance with various aspects of the present disclosure. Example 600 may illustrate an RE-level mapping scheme for a time domain interleaving configuration of a transport block of a communication. As shown in FIG. 6, a virtual resource grid may include a set of REs for one or more VRBs. For example, as shown in FIG. 6, a virtual resource grid may represent a slot that includes three VRBs (e.g., VRB 1, VRB 2, and VRB 3) associated with a quantity of REs of the set of REs. The virtual resource grid may include a quantity of REs in the frequency domain and a quantity of OFDM symbols in the time domain. The quantity of REs and/or the quantity of OFDM symbols may be based at least in part on a frame structure for the communication. The virtual resource grid may include one or more symbols of the virtual resource grid that are allocated for DMRSs (e.g., three symbols as shown in FIG. 6).

As described above with respect to FIG. 5, a wireless communication device (e.g., a UE 120 or a base station 110) may determine a time domain interleaving configuration for a transport block of a communication. For example, the wireless communication device may concatenate CBs of the transport block and modulate REs of the CBs. The wireless communication device may apply a layer level mapping scheme to the CBs and/or the modulated REs. The wireless communication device may determine that a time domain interleaving configuration for a transport block of a communication includes an RE-level mapping (e.g., in the frequency domain and the time domain) for the modulated REs of the CBs. For example, as shown in FIG. 6, the wireless communication device may map the modulated REs to REs of one or more VRBs according to an RE-level mapping scheme. The RE-level mapping scheme may follow a zig-zag pattern, as shown in FIG. 6.

As shown by reference number 605, the wireless communication device may map a first modulated RE of a transport block to a first RE of the set of REs associated with the VRBs. The first RE of the set of REs associated with the VRBs may be a first available RE in the time domain and a first available RE in the frequency domain. For example, the first RE of the set of REs associated with the VRBs may occupy a first available symbol in a slot associated with the VRBs and may be a highest frequency of a bandwidth associated with the VRBs. In some aspects, the first RE of the set of REs associated with the VRBs may occupy a lowest frequency of the bandwidth associated with the VRBs.

The wireless communication device may determine one or more reserved REs and/or one or more reserved symbols. A reserved RE may be an RE that is associated with a DMRS, an RE for which rate matching is to be used, and/or the like. The wireless communication device may refrain from mapping a modulated RE to a reserved RE. As shown in FIG. 6, the first two symbols may be associated with receiving communications and the third symbol may be associated with a DMRS. As a result, the first available symbol may be the fourth symbol.

The modulated REs may be mapped in strings of REs or “zig-zags.” For example, in a first string, after mapping the first modulated RE to the first RE of the VRBs, the wireless communication device may map a second modulated RE to a second RE of the VRBs. The second RE of the VRBs may be a next available RE following the zig-zag pattern. The zig-zag pattern may be based at least in part on a time domain shift (e.g., one or more symbols) and a frequency domain shift (e.g., one or more REs) from the first RE. For example, as shown in FIG. 6, the next available RE may be shifted one symbol in the time domain from the first RE and one RE in the frequency domain from the first RE. An available RE may be an RE that is not a reserved RE, an RE that is not already associated with a modulated RE, and/or the like. The wireless communication device may continue to follow the zig-zag pattern for a string across REs of the VRBs (e.g., shifting by one symbol in the time and by one RE in the frequency domain) until the wireless communication device determines that an RE in the pattern is an available RE.

As shown by reference number 610, the wireless communication device may determine that a mapped RE (e.g., an RE of the VRBs that is associated with a modulated RE) is a last RE of the VRBs in the time domain in a direction. The wireless communication device may determine that a time domain shift (e.g., according to the zig-zag pattern), from the mapped RE, is to a next available time domain resource that is adjacent to the last time domain resource associated with the one or more VRBs. That is, the wireless communication device may determine that the time domain shift for the next RE may be in an opposite direction from a previous time domain shift to an adjacent symbol to the last symbol associated with the VRBs.

As shown by reference number 615, the wireless communication device may continue to map modulated REs to REs of the VRBs in the first string according to the zig-zag pattern until the wireless communication device maps a modulated RE to an RE of the VRB that occupies a last frequency domain resource of the REs of the VRBs. The wireless communication device may determine that a string of REs may terminate or end based at least in part on mapping a modulated RE to an RE of the VRB that occupies a last frequency domain resource of the REs of the VRBs while following the zig-zag pattern.

As shown by reference number 620, the wireless communication device may start a new string (e.g., the second string) based at least in part on mapping a modulated RE to an RE of the VRB that occupies a last frequency domain resource of the REs of the VRBs while following the zig-zag pattern. The wireless communication device may determine a next RE of the VRBs to be mapped (e.g., a first RE in the second string) after an RE of the VRB that occupies a last frequency domain resource of the REs of the VRBs (e.g., after the last RE of the first string) based at least in part on the initial RE in the first string. For example, the first RE in the second string may be shifted in the time domain or the frequency domain from the first RE in the first string. That is, the first RE in the second string may occupy a same time domain resource as the first RE in the first string and a frequency domain resource that is shifted by at least one RE in the frequency domain from a frequency domain resource of the first RE in the first string (e.g., as shown in FIG. 6). In some aspects, the first RE in the second string may occupy a same frequency domain resource as the first RE in the first string and a time domain resource that is shifted by at least one symbol in the time domain from a time domain resource of the first RE in the first string. The wireless communication device may map modulated REs in the second string according to the zig-zag pattern (e.g., in a similar manner as described above with respect to the first string).

As shown in FIG. 6, the wireless communication device may map a third string of REs of the VRBs in a similar manner as described above with respect to the first string. As shown by reference number 625, the wireless communication device may determine that a next RE according to the zig-zag pattern has been mapped to a modulated RE in a different string. For example, as shown in FIG. 6, an RE in the third string according to the zig-zag pattern was mapped to a modulated RE during the first string. The wireless communication device may determine that the RE that was mapped to a modulated RE during the first string is to be skipped. The wireless communication device may follow the zig-zag pattern from the RE that was mapped to a modulated RE during the first string (e.g., shifting one symbol in the time domain and one RE in the frequency domain) to determine a next available RE to be mapped to a modulated RE. The wireless communication device may follow a similar approach when the wireless communication device determines that a next RE in a string according to the zig-zag pattern is a reserved RE (e.g., an RE allocated to a DMRS, an RE for which rate matching is to be used, and/or the like).

The wireless communication device may continue mapping modulated REs of CBs of a transport block to the REs of the VRBs following the zig-zag pattern, as described above, until the wireless communication device determines there is not a next available RE according to the zig-zag pattern. As shown by reference number 630, there may be a set of remaining REs of the VRBs that are not mapped according to the zig-zag pattern. The wireless communication device may determine another RE-level time domain and frequency domain mapping for the set of remaining REs of the VRBs. For example, the wireless communication device may map modulated REs to the set of remaining REs following the pattern depicted by the arrow in FIG. 6 (e.g., in a single string or zig-zag, and/or the like). In some aspects, the wireless communication device may map modulated REs to the set of remaining REs following the pattern depicted by the arrow in FIG. 6, in an opposite direction as depicted by the arrow. In some aspects, the wireless communication device may map modulated REs to the set of remaining REs after mapping modulated REs to the REs of the VRBs following the zig-zag pattern. In some aspects, the wireless communication device may map modulated REs to the set of remaining REs before mapping modulated REs to the REs of the VRBs following the zig-zag pattern.

In some aspects, the wireless communication device may follow a similar RE-level mapping as described above for a time domain sub-block interleaving configuration (e.g., the sub-block interleaving configuration described above with respect to FIG. 5). In some aspects, the wireless communication device may apply VRB-to-PRB mapping after applying the RE-level mapping scheme described above. In some aspects, the VRB-to-PRB mapping scheme may be an interleaved VRB-to-PRB mapping scheme. As a result, the wireless communication device may maintain the frequency diversity achieved using the VRB-to-PRB mapping scheme while also introducing time domain diversity using the RE-level mapping scheme described above.

As indicated above, FIG. 6 is provided as an example. Other examples may differ from what is described with respect to FIG. 6.

FIG. 7 is a diagram illustrating an example 700 associated with time domain interleaving for physical shared channel communications, in accordance with various aspects of the present disclosure. Example 700 may illustrate a time domain cyclic shift configuration associated with one or more VRBs (e.g., 9 VRBs as shown in FIG. 7). A VRB may include one or more symbols in the time domain and one or more REs in the frequency domain. In some aspects, a VRB may include one or more symbols allocated for a DMRS (e.g., 3 symbols as shown in FIG. 7).

A wireless communication device (e.g., a UE 120 or a base station 110) may determine a time domain interleaving configuration for a transport block of a communication. For example, the wireless communication device may concatenate CBs of the transport block and modulate REs of the CBs. The wireless communication device may apply a layer level mapping scheme to the CBs and/or the modulated REs. The wireless communication device may determine that a time domain interleaving configuration for a transport block of a communication includes a time domain, VRB-specific, cyclic shift configuration.

As shown by reference number 705, the wireless communication device may map the modulated REs of the CBs of the transport block to the one or more VRBs (e.g., in the time domain and the frequency domain). For example, as shown in FIG. 7, a VRB of the one or more VRBs may have modulated REs of the CBs mapped to REs in 9 symbols (e.g., the shaded symbols in FIG. 7, not including the DMRS symbols).

As shown by reference number 710, the wireless communication device may determine a cyclic shift step associated with a VRB of the one or more VRBs. The cyclic shift step may be defined in terms of a quantity of symbols. The cyclic shift step may be a quantity of symbols that the symbols of the VRB are to be shifted by in the time domain. In some aspects, the quantity of symbols may be based at least in part on an index associated with the VRB of the one or more VRBs (e.g., the cyclic shift step may be VRB-specific). In some aspects, a cyclic shift step according to the time domain cyclic shift configuration may be increased by a quantity of symbols for each increase in VRB index (e.g., a first VRB may have a cyclic shift step of 0 symbols, a second VRB may have a cyclic shift step of 1 symbol, a third VRB may have a cyclic shift step of 2 symbols, and so on).

In some aspects, the wireless communication device may determine that symbols of the one or more VRBs associated with or allocated for a DMRS are not to be included in the time domain cyclic shift configuration (e.g., the symbols allocated for a DMRS may not be shifted when the time domain cyclic shift configuration is applied to the one or more VRBs). In some aspects, the wireless communication device may determine that symbols of the one or more VRBs that overlap with other signals to be transmitted by the wireless communication device are not to be included in the time domain cyclic shift configuration. In some aspects, the wireless communication device may not assume rate matching if the time domain cyclic shift configuration is to be used.

In some aspects, the time domain cyclic shift configuration may be based at least in part on a size of a PRB group associated with the communication. In some aspects, the time domain cyclic shift configuration may be based at least in part on a size of a sub-PRB.

As shown by reference number 715, the one or more VRBs may be cyclic shifted in the time domain according to a cyclic shift step associated with each VRB. For example, the first VRB may not be cyclic shifted (e.g., the cyclic shift step associated with the first VRB may be 0 symbols). The second VRB may be cyclic shifted by 1 symbol (e.g., the symbols of the second VRB may be shifted by 1 symbol in the time domain). The third VRB may be cyclic shifted by 2 symbols (e.g., the symbols of the third VRB may be shifted by 4 symbols in the time domain). The remaining VRBs may be cyclic shifted in a similar manner according to a cyclic shift step associated with each VRB.

In some aspects, the wireless communication device may apply VRB-to-PRB mapping after applying the time domain cyclic shift configuration described above. In some aspects, the VRB-to-PRB mapping scheme may be an interleaved VRB-to-PRB mapping scheme. As a result, the wireless communication device may maintain the frequency diversity achieved using the VRB-to-PRB mapping scheme while also introducing time domain diversity using the time domain cyclic shift configuration described above.

As indicated above, FIG. 7 is provided as an example. Other examples may differ from what is described with respect to FIG. 7.

FIG. 8 is a diagram illustrating an example process 800 performed, for example, by a wireless communication device, in accordance with various aspects of the present disclosure. Example process 800 is an example where the wireless communication device (e.g., UE 120, base station 110, and/or the like) performs operations associated with time domain interleaving for physical shared channel communications.

As shown in FIG. 8, in some aspects, process 800 may include determining a time domain interleaving configuration to be used for a transport block of a communication, wherein the time domain interleaving configuration maintains a frequency domain resource distribution of a frequency domain resource mapping scheme used for the transport block (block 810). For example, the wireless communication device (e.g., using antenna 234, DEMOD 232, MIMO detector 236, receive processor 238, controller/processor 240, antenna 252, DEMOD 254, MIMO detector 256, receive processor 258, controller/processor 280, and/or the like) may determine a time domain interleaving configuration to be used for a transport block of a communication, as described above. In some aspects, the time domain interleaving configuration maintains a frequency domain resource distribution of a frequency domain resource mapping scheme used for the transport block. In some aspects, the wireless communication device may determine the time domain interleaving configuration based at least in part on a configuration of the transport block (e.g., a quantity of code blocks included in the transport block and/or the like), a scheduled bandwidth for the transport block, a scheduled quantity of OFDM symbols for the transport block, and/or the like.

As further shown in FIG. 8, in some aspects, process 800 may include transmitting the communication on one or more physical shared channels using the time domain interleaving configuration for the transport block of the communication (block 820). For example, the wireless communication device (e.g., using antenna 234, DEMOD 232, MIMO detector 236, receive processor 238, controller/processor 240, antenna 252, DEMOD 254, MIMO detector 256, receive processor 258, controller/processor 280, and/or the like) may transmit the communication on one or more physical shared channels using the time domain interleaving configuration for the transport block of the communication, as described above.

Process 800 may include additional aspects, such as any single aspect or any combination of aspects described below and/or in connection with one or more other processes described elsewhere herein.

In a first aspect, the frequency domain resource mapping scheme used for the transport block is a virtual resource block to physical resource block mapping scheme.

In a second aspect, alone or in combination with the first aspect, the transport block includes a plurality of coded bits, and determining the time domain interleaving configuration comprises determining a time domain interleaving configuration for the plurality of coded bits across the transport block.

In a third aspect, alone or in combination with one or more of the first and second aspects, the transport block includes one or more code blocks, and determining the time domain interleaving configuration comprises determining a time domain sub-block interleaving configuration for one or more sub-blocks of the one or more code blocks across the transport block.

In a fourth aspect, alone or in combination with one or more of the first through third aspects, determining the time domain sub-block interleaving configuration for the one or more sub-blocks of the one or more code blocks across the transport block comprises segmenting each code block, of the one or more code blocks, into the one or more sub-blocks, and determining the time domain sub-block interleaving configuration for one or more sub-blocks of each code block, of the one or more code blocks, across the transport block based at least in part on segmenting each code block into the one or more sub-blocks.

In a fifth aspect, alone or in combination with one or more of the first through fourth aspects, the transport block includes one or more concatenated code blocks, and the one or more concatenated code blocks include one or more modulated resource elements (REs).

In a sixth aspect, alone or in combination with one or more of the first through fifth aspects, determining the time domain interleaving configuration comprises determining a time domain and frequency domain mapping of the one or more modulated REs to one or more virtual resource blocks (VRBs).

In a seventh aspect, alone or in combination with one or more of the first through sixth aspects, the time domain and frequency domain mapping of the one or more modulated REs to the one or more VRBs follows a zig-zag pattern.

In an eighth aspect, alone or in combination with one or more of the first through seventh aspects, determining the time domain and frequency domain mapping of the one or more modulated REs to the one or more VRBs comprises determining one or more reserved REs associated with the one or more VRBs, and refraining from mapping a modulated RE, of the one or more modulated REs, to a reserved RE of the one or more reserved REs.

In a ninth aspect, alone or in combination with one or more of the first through eighth aspects, a reserved RE includes an RE that is associated with a demodulation reference signal, or an RE for which rate matching is to be used.

In a tenth aspect, alone or in combination with one or more of the first through ninth aspects, determining the time domain and frequency domain mapping of the one or more modulated REs to the one or more VRBs comprises performing rate matching for the one or more modulated REs.

In an eleventh aspect, alone or in combination with one or more of the first through tenth aspects, determining the time domain and frequency domain mapping of the one or more modulated REs to the one or more VRBs comprises determining a set of REs associated with the one or more VRBs, and mapping a first modulated RE, of the one or more modulated REs, to a first RE of the set of REs associated with the one or more VRBs.

In a twelfth aspect, alone or in combination with one or more of the first through eleventh aspects, the first RE occupies a first time domain resource and a first frequency domain resource associated with the set of REs associated with the one or more VRBs.

In a thirteenth aspect, alone or in combination with one or more of the first through twelfth aspects, the first time domain resource associated with the set of REs is a first available symbol in a slot associated with the one or more VRBs, and the first frequency domain resource associated with the set of REs is a highest frequency of a bandwidth associated with the one or more VRBs or a lowest frequency of the bandwidth associated with the one or more VRBs.

In a fourteenth aspect, alone or in combination with one or more of the first through thirteenth aspects, determining the time domain and frequency domain mapping of the one or more modulated REs to the one or more VRBs comprises determining a next available RE, of the set of REs associated with the one or more VRBs, based at least in part on a time domain shift and a frequency domain shift from the first RE, and mapping a second modulated RE, of the one or more modulated REs, to the next available RE.

In a fifteenth aspect, alone or in combination with one or more of the first through fourteenth aspects, the time domain shift is at least one symbol in the time domain and the frequency domain shift is at least one RE in the frequency domain.

In a sixteenth aspect, alone or in combination with one or more of the first through fifteenth aspects, an available RE, of the set of REs associated with the one or more VRBs, includes an RE, of the set of REs associated with the one or more VRBs, that is not associated with a modulated RE of the one or more modulated REs, or an RE, of the set of REs associated with the one or more VRBs, that is not a reserved RE.

In a seventeenth aspect, alone or in combination with one or more of the first through sixteenth aspects, determining a next available RE, of the set of REs associated with the one or more VRBs, comprises determining that the first RE occupies a last time domain resource associated with the one or more VRBs, and determining that the time domain shift from the first RE is to a next available time domain resource, that is associated with the one or more VRBs, that is adjacent to the last time domain resource associated with the one or more VRBs.

In an eighteenth aspect, alone or in combination with one or more of the first through seventeenth aspects, determining a next available RE, of the set of REs associated with the one or more VRBs, comprises determining that the first RE occupies a last frequency domain resource associated with the set of REs associated with the one or more VRBs; determining an initial RE in a string of REs associated with the first RE, and determining that the next available RE is an RE occupying a same frequency domain resource as the initial RE and a time domain resource that is shifted by at least one symbol from a time domain resource of the initial RE, or an RE occupying a same time domain resource as the initial RE and a frequency domain resource that is shifted by at least one RE in the frequency domain from a frequency domain resource of the initial RE.

In a nineteenth aspect, alone or in combination with one or more of the first through eighteenth aspects, determining the time domain and frequency domain mapping of the one or more modulated REs to the one or more VRBs comprises determining one or more REs associated with the one or more VRBs that are not mapped according to the time domain and frequency domain mapping, and determining another time domain and frequency domain mapping of the one or more modulated REs to the one or more REs associated with the one or more VRBs that are not mapped according to the time domain and frequency domain mapping.

In a twentieth aspect, alone or in combination with one or more of the first through nineteenth aspects, determining the time domain interleaving configuration comprises determining a time domain cyclic shift configuration associated with one or more VRBs based at least in part on mapping one or more code blocks of the transport block to the one or more VRBs.

In a twenty-first aspect, alone or in combination with one or more of the first through twentieth aspects, determining the time domain cyclic shift configuration associated with the one or more VRBs comprises determining a cyclic shift step associated with a VRB of the one or more VRBs.

In a twenty-second aspect, alone or in combination with one or more of the first through twenty-first aspects, the cyclic shift step is defined in terms of a quantity of symbols.

In a twenty-third aspect, alone or in combination with one or more of the first through twenty-second aspects, the quantity of symbols is based at least in part on an index associated with the VRB of the one or more VRBs.

In a twenty-fourth aspect, alone or in combination with one or more of the first through twenty-third aspects, determining the time domain cyclic shift configuration associated with the one or more VRBs comprises refraining from including one or more symbols associated with the one or more VRBs in the time domain cyclic shift configuration that overlap with one or more signals to be transmitted by the wireless communication device.

In a twenty-fifth aspect, alone or in combination with one or more of the first through twenty-fourth aspects, mapping the one or more code blocks of the transport block to the one or more VRBs comprises refraining from mapping a code block of the one or more code blocks to a symbol associated with the one or more VRBs, wherein the symbol is associated with a demodulation reference signal

In a twenty-sixth aspect, alone or in combination with one or more of the first through twenty-fifth aspects, the time domain cyclic shift configuration is based at least in part on a size of a physical resource block group associated with the communication.

In a twenty-seventh aspect, alone or in combination with one or more of the first through twenty-sixth aspects, the communication is associated with a plurality of transport blocks, and determining the time domain interleaving configuration comprises determining a time domain interleaving configuration for the plurality of transport blocks.

In a twenty-eighth aspect, alone or in combination with one or more of the first through twenty-seventh aspects, the communication is associated with a plurality of transport blocks, and determining the time domain interleaving configuration comprises determining a time domain interleaving configuration for a transport block of the plurality of transport blocks.

In a twenty-ninth aspect, alone or in combination with one or more of the first through twenty-eighth aspects, transmitting the communication on the one or more physical shared channels comprises transmitting the communication using a plurality of slots according to a multi-transmission-time-interval configuration, and determining the time domain interleaving configuration comprises determining a time domain interleaving configuration for a slot of the plurality of slots.

In a thirtieth aspect, alone or in combination with one or more of the first through twenty-ninth aspects, transmitting the communication on the one or more physical shared channels comprises transmitting the communication using a plurality of slots according to a multi-transmission-time-interval configuration, and determining the time domain interleaving configuration comprises determining a time domain interleaving configuration across the plurality of slots.

In a thirty-first aspect, alone or in combination with one or more of the first through thirtieth aspects, the wireless communication device is a user equipment, and determining the time domain interleaving configuration comprises receiving, from a base station, an indication of the time domain interleaving configuration in a radio resource control communication or a downlink control information communication.

In a thirty-second aspect, alone or in combination with one or more of the first through thirty-first aspects, the wireless communication device is a base station, and process 800 further comprises transmitting, to a user equipment, a radio resource control communication or a downlink control information communication indicating the time domain interleaving configuration.

In a thirty-third aspect, alone or in combination with one or more of the first through thirty-second aspects, determining the time domain interleaving configuration is based at least in part on at least one of a quantity of code blocks associated with the transport block, a quantity of code block groups associated with the transport block, a bandwidth associated with the transport block, a quantity of symbols associated with the transport block, a quantity of layers associated with the communication, a quantity of transport blocks associated with the communication, a quantity of symbols of the communication that are associated with a demodulation reference signal, a frequency domain interleaving pattern associated with the communication, a modulation and coding scheme associated with the communication, or a combination thereof.

In a thirty-fourth aspect, alone or in combination with one or more of the first through thirty-third aspects, process 800 includes determining a channel quality indicator (CQI) calculation associated with the communication based at least in part on determining the time domain interleaving configuration.

In a thirty-fifth aspect, alone or in combination with one or more of the first through thirty-fourth aspects, the wireless communication device is a user equipment, and determining the CQI calculation associated with the communication comprises transmitting, to a base station, a channel state information report indicating the CQI calculation, where the report includes at least one of an indication of whether a time domain interleaving configuration for the communication was assumed in determining the CQI calculation, or an indication of the time domain interleaving configuration for the communication that was assumed in determining the CQI calculation.

In a thirty-sixth aspect, alone or in combination with one or more of the first through thirty-fifth aspects, the wireless communication device is a base station, and determining the CQI calculation associated with the communication comprises transmitting, to a user equipment, a configuration for a channel state information report, where the configuration indicates the time domain interleaving configuration to be assumed in determining the CQI calculation.

In a thirty-seventh aspect, alone or in combination with one or more of the first through thirty-sixth aspects, determining the CQI calculation associated with the communication comprises determining a block error rate target for the CQI calculation, where the block error rate is based at least in part on the time domain interleaving configuration.

In a thirty-eighth aspect, alone or in combination with one or more of the first through thirty-seventh aspects, determining the CQI calculation associated with the communication comprises determining a bandwidth associated with a channel state information resource associated with the CQI calculation based at least in part on the time domain interleaving configuration.

In a thirty-ninth aspect, alone or in combination with one or more of the first through thirty-eighth aspects, determining the bandwidth associated with the channel state information resource comprises determining that the bandwidth associated with the channel state information resource is a sub-band associated with a channel state information report for the CQI calculation.

In a fortieth aspect, alone or in combination with one or more of the first through thirty-ninth aspects, determining the bandwidth associated with the channel state information resource comprises determining that the bandwidth associated with the channel state information resource is a bandwidth part associated with the communication.

In a forty-first aspect, alone or in combination with one or more of the first through fortieth aspects, the communication is an uplink communication or a downlink communication.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a wireless communication device, in accordance with various aspects of the present disclosure. Example process 900 is an example where the wireless communication device (e.g., UE 120, base station 110, and/or the like) performs operations associated with time domain interleaving for physical shared channel communications.

As shown in FIG. 9, in some aspects, process 900 may include determining a time domain interleaving configuration to be used for a transport block of a communication, wherein the time domain interleaving configuration maintains a frequency domain resource distribution of a frequency domain resource mapping scheme used for the transport block (block 910). For example, the wireless communication device (e.g., using antenna 234, DEMOD 232, MIMO detector 236, receive processor 238, controller/processor 240, antenna 252, DEMOD 254, MIMO detector 256, receive processor 258, controller/processor 280, and/or the like) may determine a time domain interleaving configuration to be used for a transport block of a communication, as described above. In some aspects, the time domain interleaving configuration maintains a frequency domain resource distribution of a frequency domain resource mapping scheme used for the transport block. In some aspects, the wireless communication device may determine the time domain interleaving configuration based at least in part on a configuration of the transport block (e.g., a quantity of code blocks included in the transport block and/or the like), a scheduled bandwidth for the transport block, a scheduled quantity of OFDM symbols for the transport block, and/or the like.

As further shown in FIG. 9, in some aspects, process 900 may include receiving the communication on one or more physical shared channels using the time domain interleaving configuration for the transport block of the communication (block 920). For example, the wireless communication device (e.g., using antenna 234, DEMOD 232, MIMO detector 236, receive processor 238, controller/processor 240, antenna 252, DEMOD 254, MIMO detector 256, receive processor 258, controller/processor 280, and/or the like) may receive the communication on one or more physical shared channels using the time domain interleaving configuration for the transport block of the communication, as described above.

Process 900 may include additional aspects, such as any single aspect or any combination of aspects described below and/or in connection with one or more other processes described elsewhere herein.

In a first aspect, the frequency domain resource mapping scheme used for the transport block is a virtual resource block to physical resource block mapping scheme.

In a second aspect, alone or in combination with the first aspect, the transport block includes a plurality of coded bits, and determining the time domain interleaving configuration comprises determining a time domain interleaving configuration for the plurality of coded bits across the transport block.

In a third aspect, alone or in combination with one or more of the first and second aspects, the transport block includes one or more code blocks, and determining the time domain interleaving configuration comprises determining a time domain sub-block interleaving configuration for one or more sub-blocks of the one or more code blocks across the transport block.

In a fourth aspect, alone or in combination with one or more of the first through third aspects, determining the time domain sub-block interleaving configuration for the one or more sub-blocks of the one or more code blocks across the transport block comprises segmenting each code block, of the one or more code blocks, into the one or more sub-blocks, and determining the time domain sub-block interleaving configuration for one or more sub-blocks of each code block, of the one or more code blocks, across the transport block based at least in part on segmenting each code block into the one or more sub-blocks.

In a fifth aspect, alone or in combination with one or more of the first through fourth aspects, the transport block includes one or more concatenated code blocks, and wherein the one or more concatenated code blocks include one or more modulated resource elements (REs)

In a sixth aspect, alone or in combination with one or more of the first through fifth aspects, determining the time domain interleaving configuration comprises determining a time domain and frequency domain mapping of the one or more modulated REs to one or more virtual resource blocks (VRBs).

In a seventh aspect, alone or in combination with one or more of the first through sixth aspects, the time domain and frequency domain mapping of the one or more modulated REs to the one or more VRBs follows a zig-zag pattern.

In an eighth aspect, alone or in combination with one or more of the first through seventh aspects, determining the time domain and frequency domain mapping of the one or more modulated REs to the one or more VRBs comprises determining one or more reserved REs associated with the one or more VRBs, and refraining from mapping a modulated RE, of the one or more modulated REs, to a reserved RE of the one or more reserved REs.

In a ninth aspect, alone or in combination with one or more of the first through eighth aspects, a reserved RE includes an RE that is associated with a demodulation reference signal, or an RE for which rate matching is to be used.

In a tenth aspect, alone or in combination with one or more of the first through ninth aspects, determining the time domain and frequency domain mapping of the one or more modulated REs to the one or more VRBs comprises performing rate matching for the one or more modulated REs.

In an eleventh aspect, alone or in combination with one or more of the first through tenth aspects, determining the time domain and frequency domain mapping of the one or more modulated REs to the one or more VRBs comprises determining a set of REs associated with the one or more VRBs, and mapping a first modulated RE, of the one or more modulated REs, to a first RE of the set of REs associated with the one or more VRBs.

In a twelfth aspect, alone or in combination with one or more of the first through eleventh aspects, the first RE occupies a first time domain resource and a first frequency domain resource associated with the set of REs associated with the one or more VRBs.

In a thirteenth aspect, alone or in combination with one or more of the first through twelfth aspects, the first time domain resource associated with the set of REs is a first available symbol in a slot associated with the one or more VRBs, and the first frequency domain resource associated with the set of REs is a highest frequency of a bandwidth associated with the one or more VRBs or a lowest frequency of the bandwidth associated with the one or more VRBs.

In a fourteenth aspect, alone or in combination with one or more of the first through thirteenth aspects, determining the time domain and frequency domain mapping of the one or more modulated REs to the one or more VRBs comprises determining a next available RE, of the set of REs associated with the one or more VRBs, based at least in part on a time domain shift and a frequency domain shift from the first RE, and mapping a second modulated RE, of the one or more modulated REs, to the next available RE.

In a fifteenth aspect, alone or in combination with one or more of the first through fourteenth aspects, the time domain shift is at least one symbol in the time domain and the frequency domain shift is at least one RE in the frequency domain.

In a sixteenth aspect, alone or in combination with one or more of the first through fifteenth aspects, an available RE, of the set of REs associated with the one or more VRBs, includes an RE, of the set of REs associated with the one or more VRBs, that is not associated with a modulated RE of the one or more modulated REs, or an RE, of the set of REs associated with the one or more VRBs, that is not a reserved RE.

In a seventeenth aspect, alone or in combination with one or more of the first through sixteenth aspects, determining a next available RE, of the set of REs associated with the one or more VRBs, comprises determining that the first RE occupies a last time domain resource associated with the one or more VRBs, and determining that the time domain shift from the first RE is to a next available time domain resource, that is associated with the one or more VRBs, that is adjacent to the last time domain resource associated with the one or more VRBs.

In an eighteenth aspect, alone or in combination with one or more of the first through seventeenth aspects, determining a next available RE, of the set of REs associated with the one or more VRBs, comprises determining that the first RE occupies a last frequency domain resource associated with the set of REs associated with the one or more VRBs; determining an initial RE in a string of REs associated with the first RE, and determining that the next available RE is an RE occupying a same frequency domain resource as the initial RE and a time domain resource that is shifted by at least one symbol from a time domain resource of the initial RE, or an RE occupying a same time domain resource as the initial RE and a frequency domain resource that is shifted by at least one RE in the frequency domain from a frequency domain resource of the initial RE.

In a nineteenth aspect, alone or in combination with one or more of the first through eighteenth aspects, determining the time domain and frequency domain mapping of the one or more modulated REs to the one or more VRBs comprises determining one or more REs associated with the one or more VRBs that are not mapped according to the time domain and frequency domain mapping, and determining another time domain and frequency domain mapping of the one or more modulated REs to the one or more REs associated with the one or more VRBs that are not mapped according to the time domain and frequency domain mapping.

In a twentieth aspect, alone or in combination with one or more of the first through nineteenth aspects, determining the time domain interleaving configuration comprises determining a time domain cyclic shift configuration associated with one or more virtual resource blocks (VRBs) based at least in part on mapping one or more code blocks of the transport block to the one or more VRBs.

In a twenty-first aspect, alone or in combination with one or more of the first through twentieth aspects, determining the time domain cyclic shift configuration associated with the one or more VRBs comprises determining a cyclic shift step associated with a VRB of the one or more VRBs.

In a twenty-second aspect, alone or in combination with one or more of the first through-twenty first aspects, the cyclic shift step is defined in terms of a quantity of symbols.

In a twenty-third aspect, alone or in combination with one or more of the first through twenty-second aspects, the quantity of symbols is based at least in part on an index associated with the VRB of the one or more VRBs.

In a twenty-fourth aspect, alone or in combination with one or more of the first through twenty-third aspects, determining the time domain cyclic shift configuration associated with the one or more VRBs comprises refraining from including one or more symbols associated with the one or more VRBs in the time domain cyclic shift configuration that overlap with one or more signals to be received by the wireless communication device.

In a twenty-fifth aspect, alone or in combination with one or more of the first through twenty-fourth aspects, mapping the one or more code blocks of the transport block to the one or more VRBs comprises refraining from mapping a code block of the one or more code blocks to a symbol associated with the one or more VRBs, wherein the symbol is associated with a demodulation reference signal

In a twenty-sixth aspect, alone or in combination with one or more of the first through twenty-fifth aspects, the time domain cyclic shift configuration is based at least in part on a size of a physical resource block group associated with the communication.

In a twenty-seventh aspect, alone or in combination with one or more of the first through twenty-sixth aspects, the communication is associated with a plurality of transport blocks, and determining the time domain interleaving configuration comprises determining a time domain interleaving configuration for the plurality of transport blocks.

In a twenty-eighth aspect, alone or in combination with one or more of the first through twenty-seventh aspects, the communication is associated with a plurality of transport blocks, and determining the time domain interleaving configuration comprises determining a time domain interleaving configuration for a transport block of the plurality of transport blocks.

In a twenty-ninth aspect, alone or in combination with one or more of the first through twenty-eighth aspects, receiving the communication on the one or more physical shared channels comprises receiving the communication using a plurality of slots according to a multi-transmission-time-interval configuration, and determining the time domain interleaving configuration comprises determining a time domain interleaving configuration for a slot of the plurality of slots.

In a thirtieth aspect, alone or in combination with one or more of the first through twenty-ninth aspects, receiving the communication on the one or more physical shared channels comprises receiving the communication using a plurality of slots according to a multi-transmission-time-interval configuration, and determining the time domain interleaving configuration comprises determining a time domain interleaving configuration across the plurality of slots.

In a thirty-first aspect, alone or in combination with one or more of the first through thirtieth aspects, the wireless communication device is a user equipment, and determining the time domain interleaving configuration comprises receiving, from a base station, an indication of the time domain interleaving configuration in a radio resource control communication or a downlink control information communication.

In a thirty-second aspect, alone or in combination with one or more of the first through thirty-first aspects, the wireless communication device is a base station, and process 900 further comprises transmitting, to a user equipment, a radio resource control communication or a downlink control information communication indicating the time domain interleaving configuration.

In a thirty-third aspect, alone or in combination with one or more of the first through thirty-second aspects, determining the time domain interleaving configuration is based at least in part on at least one of a quantity of code blocks associated with the transport block, a quantity of code block groups associated with the transport block, a bandwidth associated with the transport block, a quantity of symbols associated with the transport block, a quantity of layers associated with the communication, a quantity of transport blocks associated with the communication, a quantity of symbols of the communication that are associated with a demodulation reference signal, a frequency domain interleaving pattern associated with the communication, a modulation and coding scheme associated with the communication, or a combination thereof.

In a thirty-fourth aspect, alone or in combination with one or more of the first through thirty-third aspects, process 900 includes determining a channel quality indicator (CQI) calculation associated with the communication based at least in part on determining the time domain interleaving configuration.

In a thirty-fifth aspect, alone or in combination with one or more of the first through thirty-fourth aspects, the wireless communication device is a user equipment, and determining the CQI calculation associated with the communication comprises transmitting, to a base station, a channel state information report indicating the CQI calculation, the report includes at least one of an indication of whether a time domain interleaving configuration for the communication was assumed in determining the CQI calculation, or an indication of the time domain interleaving configuration for the communication that was assumed in determining the CQI calculation.

In a thirty-sixth aspect, alone or in combination with one or more of the first through thirty-fifth aspects, the wireless communication device is a base station, and determining the CQI calculation associated with the communication comprises transmitting, to a user equipment, a configuration for a channel state information report, where the configuration indicates the time domain interleaving configuration to be assumed in determining the CQI calculation.

In a thirty-seventh aspect, alone or in combination with one or more of the first through thirty-sixth aspects, determining the CQI calculation associated with the communication comprises determining a block error rate target for the CQI calculation, where the block error rate is based at least in part on the time domain interleaving configuration.

In a thirty-eighth aspect, alone or in combination with one or more of the first through thirty-seventh aspects, determining the CQI calculation associated with the communication comprises determining a bandwidth associated with a channel state information resource associated with the CQI calculation based at least in part on the time domain interleaving configuration.

In a thirty-ninth aspect, alone or in combination with one or more of the first through thirty-eighth aspects, determining the bandwidth associated with the channel state information resource comprises determining that the bandwidth associated with the channel state information resource is a sub-band associated with a channel state information report for the CQI calculation.

In a fortieth aspect, alone or in combination with one or more of the first through thirty-ninth aspects, determining the bandwidth associated with the channel state information resource comprises determining that the bandwidth associated with the channel state information resource is a bandwidth part associated with the communication.

In a forty-first aspect, alone or in combination with one or more of the first through fortieth aspects, the communication is an uplink communication or a downlink communication.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

The foregoing disclosure provides illustration and description, but is not intended to be exhaustive or to limit the aspects to the precise form disclosed.

Modifications and variations may be made in light of the above disclosure or may be acquired from practice of the aspects.

As used herein, the term “component” is intended to be broadly construed as hardware, firmware, and/or a combination of hardware and software. As used herein, a processor is implemented in hardware, firmware, and/or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, and/or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” and/or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A method of wireless communication performed by a wireless communication device, comprising:
determining a time domain interleaving configuration to be used for a transport block of a communication, wherein the time domain interleaving configuration maintains a frequency domain resource distribution of a frequency domain resource mapping scheme used for the transport block; and
transmitting the communication on one or more physical shared channels using the time domain interleaving configuration for the transport block of the communication.

2. (canceled)

3. The method claim 1, wherein the transport block includes a plurality of coded bits, and
wherein determining the time domain interleaving configuration comprises:
determining a time domain interleaving configuration for the plurality of coded bits across the transport block.

4. The method claim 1, wherein the transport block includes one or more code blocks, and
wherein determining the time domain interleaving configuration comprises:
determining a time domain sub-block interleaving configuration for one or more sub-blocks of the one or more code blocks across the transport block.

5. The method of claim 4, wherein determining the time domain sub-block interleaving configuration for the one or more sub-blocks of the one or more code blocks across the transport block comprises:
segmenting each code block, of the one or more code blocks, into the one or more sub-blocks; and
determining the time domain sub-block interleaving configuration for one or more sub-blocks of each code block, of the one or more code blocks, across the transport block based at least in part on segmenting each code block into the one or more sub-blocks.

6. The method claim 1, wherein the transport block includes one or more concatenated code blocks, and wherein the one or more concatenated code blocks include one or more modulated resource elements (REs).

7. The method of claim 6, wherein determining the time domain interleaving configuration comprises:
determining a time domain and frequency domain mapping of the one or more modulated REs to one or more virtual resource blocks (VRBs), and wherein the time domain and frequency domain mapping of the one or more modulated REs to the one or more VRBs follows a zig-zag pattern.

8. (canceled)

9. The method of claim 7, wherein determining the time domain and frequency domain mapping of the one or more modulated REs to the one or more VRBs comprises:
determining one or more reserved REs associated with the one or more VRBs; and
refraining from mapping a modulated RE, of the one or more modulated REs, to a reserved RE of the one or more reserved REs.

10. (canceled)

11. (canceled)

12. The method of claim 7, wherein determining the time domain and frequency domain mapping of the one or more modulated REs to the one or more VRBs comprises:
determining a set of REs associated with the one or more VRBs; and
mapping a first modulated RE, of the one or more modulated REs, to a first RE of the set of REs associated with the one or more VRBs, wherein the first RE occupies a first time domain resource and a first frequency domain resource associated with the set of REs associated with the one or more VRBs.

13. (canceled)

14. (canceled)

15. The method of claim 12, wherein determining the time domain and frequency domain mapping of the one or more modulated REs to the one or more VRBs comprises:
determining a next available RE, of the set of REs associated with the one or more VRBs, based at least in part on a time domain shift and a frequency domain shift from the first RE, wherein the time domain shift is at least one symbol in the time domain and the frequency domain shift is at least one RE in the frequency domain; and
mapping a second modulated RE, of the one or more modulated REs, to the next available RE.

16. (canceled)

17. The method of claim 15, wherein an available RE, of the set of REs associated with the one or more VRBs, includes:
an RE, of the set of REs associated with the one or more VRBs, that is not associated with a modulated RE of the one or more modulated REs, or
an RE, of the set of REs associated with the one or more VRBs, that is not a reserved RE.

18. The method of claim 15, wherein determining a next available RE, of the set of REs associated with the one or more VRBs, comprises:
determining that the first RE occupies a last time domain resource associated with the one or more VRBs; and
determining that the time domain shift from the first RE is to a next available time domain resource, that is associated with the one or more VRBs, that is adjacent to the last time domain resource associated with the one or more VRBs.

19. The method of claim 15, wherein determining a next available RE, of the set of REs associated with the one or more VRBs, comprises:
determining that the first RE occupies a last frequency domain resource associated with the set of REs associated with the one or more VRBs;
determining an initial RE in a string of REs associated with the first RE; and
determining that the next available RE is:
an RE occupying a same frequency domain resource as the initial RE and a time domain resource that is shifted by at least one symbol from a time domain resource of the initial RE, or
an RE occupying a same time domain resource as the initial RE and a frequency domain resource that is shifted by at least one RE in the frequency domain from a frequency domain resource of the initial RE.

20. The method of claim 7, wherein determining the time domain and frequency domain mapping of the one or more modulated REs to the one or more VRBs comprises:
determining one or more REs associated with the one or more VRBs that are not mapped according to the time domain and frequency domain mapping; and
determining another time domain and frequency domain mapping of the one or more modulated REs to the one or more REs associated with the one or more VRBs that are not mapped according to the time domain and frequency domain mapping.

21. The method of claim 1, wherein determining the time domain interleaving configuration comprises:
determining a time domain cyclic shift configuration associated with one or more virtual resource blocks (VRBs) based at least in part on mapping one or more code blocks of the transport block to the one or more VRBs.

22. The method of claim 21, wherein determining the time domain cyclic shift configuration associated with the one or more VRBs comprises:
determining a cyclic shift step associated with a VRB of the one or more VRBs, wherein the cyclic shift step is defined in terms of a quantity of symbols, and wherein the quantity of symbols is based at least in part on an index associated with the VRB of the one or more VRBs.

23. (canceled)

24. (canceled)

25. The method of claim 21, wherein determining the time domain cyclic shift configuration associated with the one or more VRBs comprises:
refraining from including one or more symbols associated with the one or more VRBs in the time domain cyclic shift configuration that overlap with one or more signals to be transmitted by the wireless communication device.

26. The method of claim 21, wherein mapping the one or more code blocks of the transport block to the one or more VRBs comprises refraining from mapping a code block of the one or more code blocks to a symbol associated with the one or more VRBs, wherein the symbol is associated with a demodulation reference signal.

27. (canceled)

28. The method of claim 1, wherein the communication is associated with a plurality of transport blocks, and
wherein determining the time domain interleaving configuration comprises:
determining a time domain interleaving configuration for the plurality of transport blocks or for a transport block of the plurality of transport blocks.

29. (canceled)

30. The method of claim 1, wherein transmitting the communication on the one or more physical shared channels comprises transmitting the communication using a plurality of slots according to a multi-transmission-time-interval configuration, and
wherein determining the time domain interleaving configuration comprises:
determining a time domain interleaving configuration for a slot of the plurality of slots or determining the time domain interleaving configuration across the plurality of slots.

31. (canceled)

32. The method of claim 1, wherein the wireless communication device is a user equipment, and
wherein determining the time domain interleaving configuration comprises:
receiving, from a base station, an indication of the time domain interleaving configuration in a radio resource control communication or a downlink control information communication; and
determining the time domain interleaving configuration based at least in part on the indication.

33. The method of claim 1, wherein the wireless communication device is a base station, the method further comprising:
transmitting, to a user equipment, a radio resource control communication or a downlink control information communication indicating the time domain interleaving configuration.

34. The method of claim 1, wherein determining the time domain interleaving configuration is based at least in part on at least one of:
a quantity of code blocks associated with the transport block,
a quantity of code block groups associated with the transport block,
a bandwidth associated with the transport block,
a quantity of symbols associated with the transport block,
a quantity of layers associated with the communication,
a quantity of transport blocks associated with the communication,
a quantity of symbols of the communication that are associated with a demodulation reference signal,
a frequency domain interleaving pattern associated with the communication,
a modulation and coding scheme associated with the communication, or
a combination thereof.

35. The method of claim 1, further comprising:
determining a channel quality indicator (CQI) calculation associated with the communication based at least in part on determining the time domain interleaving configuration.

36. The method of claim 35, wherein the wireless communication device is a user equipment, and
wherein determining the CQI calculation associated with the communication comprises:
transmitting, to a base station, a channel state information report indicating the CQI calculation, wherein the report includes at least one of:
an indication of whether a time domain interleaving configuration for the communication was assumed in determining the CQI calculation, or
an indication of the time domain interleaving configuration for the communication that was assumed in determining the CQI calculation.

37. (canceled)

38. The method of claim 35, wherein determining the CQI calculation associated with the communication comprises:
determining a block error rate target for the CQI calculation, wherein the block error rate is based at least in part on the time domain interleaving configuration.

39. The method of claim 35, wherein determining the CQI calculation associated with the communication comprises:
determining a bandwidth associated with a channel state information resource associated with the CQI calculation based at least in part on the time domain interleaving configuration.

40. (canceled)

41. (canceled)

42. (canceled)

43. A method of wireless communication performed by a wireless communication device, comprising:
determining a time domain interleaving configuration to be used for a transport block of a communication, wherein the time domain interleaving configuration maintains a frequency domain resource distribution of a frequency domain resource mapping scheme used for the transport block; and
receiving the communication on one or more physical shared channels using the time domain interleaving configuration for the transport block of the communication.

44. The method of claim 43, wherein the frequency domain resource mapping scheme used for the transport block is a virtual resource block to physical resource block mapping scheme.

45. The method of claim 43, wherein the transport block includes a plurality of coded bits, and
wherein determining the time domain interleaving configuration comprises:
determining a time domain interleaving configuration for the plurality of coded bits across the transport block.

46. The method of claim 43, wherein the transport block includes one or more code blocks, and
wherein determining the time domain interleaving configuration comprises:
determining a time domain sub-block interleaving configuration for one or more sub-blocks of the one or more code blocks across the transport block.

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)

61. (canceled)

62. (canceled)

63. The method of claim 43, wherein determining the time domain interleaving configuration comprises:
determining a time domain cyclic shift configuration associated with one or more virtual resource blocks (VRBs) based at least in part on mapping one or more code blocks of the transport block to the one or more VRBs.

64. (canceled)

65. (canceled)

66. (canceled)

67. (canceled)

68. (canceled)

69. (canceled)

70. (canceled)

71. (canceled)

72. (canceled)

73. (canceled)

74. (canceled)

75. (canceled)

76. (canceled)

77. The method of claim 43, further comprising:
determining a channel quality indicator (CQI) calculation associated with the communication based at least in part on determining the time domain interleaving configuration.

78. (canceled)

79. (canceled)

80. (canceled)

81. (canceled)

82. (canceled)

83. (canceled)

84. (canceled)

85. A wireless communication device, comprising:
a memory; and
one or more processors coupled to the memory, configured to:
determine a time domain interleaving configuration to be used for a transport block of a communication, wherein the time domain interleaving configuration maintains a frequency domain resource distribution of a frequency domain resource mapping scheme used for the transport block; and
transmit the communication on one or more physical shared channels using the time domain interleaving configuration for the transport block of the communication.

86. A wireless communication device, comprising:
a memory; and
one or more processors coupled to the memory, configured to:
determine a time domain interleaving configuration to be used for a transport block of a communication, wherein the time domain interleaving configuration maintains a frequency domain resource distribution of a frequency domain resource mapping scheme used for the transport block; and
receive the communication on one or more physical shared channels using the time domain interleaving configuration for the transport block of the communication.

87. (canceled)

88. (canceled)

89. An apparatus for wireless communication, comprising:
means for determining a time domain interleaving configuration to be used for a transport block of a communication, wherein the time domain interleaving configuration maintains a frequency domain resource distribution of a frequency domain resource mapping scheme used for the transport block; and
means for transmitting the communication on one or more physical shared channels using the time domain interleaving configuration for the transport block of the communication.

90. (canceled)
